(19) United States
(12) Patent Application Publication
(10) Pub. No.: US 2022/0263120 A1
(43) Pub. Date: Aug. 18, 2022

(54) SOLID ELECTROLYTE MATERIAL, SOLID ELECTROLYTE INCLUDING THE SAME, ALL-SOLID SECONDARY BATTERY INCLUDING THE SOLID ELECTROLYTE, AND METHOD OF PREPARING THE SOLID ELECTROLYTE MATERIAL

(71) Applicant: Samsung Electronics Co., Ltd., Suwon-si (KR)

(72) Inventors: Shinya SUZUKI, Yokohama-city (JP); Tomoyuki TSUJIMURA, Yokohama-city (JP); Naoki SUZUKI, Yokohama-city (JP); Nobuyoshi YASHIRO, Yokohama-city (JP)

(21) Appl. No.: 17/544,017

(22) Filed: Dec. 7, 2021

(30) Foreign Application Priority Data
Feb. 15, 2021 (JP) 2021-21800
Jun. 16, 2021 (KR) 10-2021-0078172

(51) Int. Cl. H01M 10/0562; H01M 10/058

(52) U.S. Cl. CPC H01M 10/0562; H01M 2300/008; H01M 10/058

(57) ABSTRACT

A solid electrolyte material is represented by Formula 1

(Li₃₋ₓM1ₓ)ₐY_{b}M2_{c} Formula 1
wherein, in Formula 1,
M1 includes at least one of Na, K, Rb, Cs, or Fr,
M2 includes at least one of F, Cl, Br, or I,
0<x<3, 0.9≤a≤1.1, 0.9≤b≤1.1, and 5≤c≤7.

### CROSS-REFERENCE TO RELATED APPLICATIONS

This application claims priority to Japanese Patent Application No. 2021-021800, filed Feb. 15, 2021 in the Japanese Patent Office, and Korean Patent Application No. 10-2021-0078172, filed on Jun. 16, 2021, in the Korean Intellectual Property Office, and the benefits accruing therefrom under 35 U.S.C. § 119, the content of which are incorporated by reference herein in their entirety.

### BACKGROUND

### 1. Field

The present disclosure relates to a solid electrolyte material, a solid electrolyte including the same, and an all-solid secondary battery including the solid electrolyte.

### 2. Description of the Related Art

The use of a solid electrolyte material containing a halogen component, instead of a sulfide, is being studied as a solid electrolyte material that does not contain sulfur to avoid the formation of hydrogen sulfide from the sulfide.

However, alternative non-sulfide solid electrolyte materials have low ionic conductivity, e.g., 10⁻⁴ S/cm, thus there remains a need for a non-sulfide solid electrolyte having improved ionic conductivity.

### SUMMARY

The present disclosure has been made in view of the above object, and an object of the present disclosure is to provide a solid electrolyte material having high ionic conductivity and avoid a material that could generate hydrogen sulfide.

Additional aspects will be set forth in part in the description which follows and, in part, will be apparent from the description, or may be learned by practice of the presented embodiments of the disclosure.

As a result of intensive research by the present inventors, the present disclosure has been completed only after realizing the fact that the ionic conductivity of a solid electrolyte material is significantly improved by making a halogen-containing solid electrolyte material containing lithium, yttrium, and an alkali metal element other than lithium.

According to an embodiment, there is provided a solid electrolyte material represented by Formula 1:

(Li₃₋ₓM1ₓ)ₐY_{b}M2_{c} Formula 1

wherein, in Formula 1,

M1 includes at least one of Na, K, Rb, Cs, or Fr,

M2 includes at least one of F, Cl, Br, or I,

0<x<3, 0.9≤a≤1.1, 0.9≤b≤1.1, and 5≤c≤7.

According to an embodiment, in the solid electrolyte material, a cation ratio may satisfy 0<(M1/Li+M1)≤0.07, wherein the cation ratio is a ratio of moles of M1 to a sum of moles of Li and M1.

According to an embodiment, a and b may each be 1, and 5≤c≤7 may be satisfied. For example, a and b may each be 1, and c may be 6.

According to an embodiment, the solid electrolyte material may be represented by Formula 2:

(Li₃₋ₓM1ₓ)YM2₆ Formula 2

wherein, in Formula 2,

M1 includes at least one of Na, K, Rb, Cs, or Fr, M2 includes at least one of F, Cl, Br, or I, and x is more than 0 and less than 3.

The above-described solid electrolyte represented by Formula 1 or 2 may not contain sulfur that to avoid a material that could generate hydrogen sulfide. The disclosed solid electrolyte represented by Formula 1 or 2 may have significantly increased ionic conductivity.

According to an embodiment, when analyzed by X-ray diffraction using CuKα radiation, the solid electrolyte material may have peaks at diffraction angles of 27.72°2θ±0.50°2θ, 31.96°2θ±0.50°2θ, 46.34°2θ±0.50°2θ, 55.19°2θ±0.50°2θ and 57.39°2θ±0.50°2θ.

According to an embodiment, 0<x≤0.21 may be satisfied.

According to an embodiment, the M1 element may include at least one of Na or K.

According to an embodiment, the M2 element may include at least one of Cl or Br.

According to an embodiment, the solid electrolyte material may be represented by Formula 1-1:

(Li₃₋ₓM1ₓ)ₐY_{b}(M21_{1-α}M22_{α})_{c} Formula 1-1

wherein, in Formula 1-1,

M1 comprises at least one of Na, K, Rb, Cs, or Fr,

M21 and M22 are each independently at least one of F, Cl, Br, or I,

M21 and M22 are different from each other,

0<x<3, 0.9≤a≤1.1, 0.9≤b≤1.1, 5≤c≤7, and 0<α<1.

According to an embodiment, in Formula 1-1, M21 may Br, and M22 may be Cl.

According to an embodiment, the solid electrolyte material may be represented by Formula 1-2:

(Li₃₋ₓM1ₓ)YM21_{c1}M22_{c2} Formula 1-2

wherein, in Formula 1-2,

M1 comprises at least one of Na, K, Rb, Cs, or Fr,

M21 and M22 are each independently one of F, Cl, Br, or I,

M21 and M22 are different from each other,

0<x<3, 0<c1<6, 0<c2<6, and 5≤c1+c2≤7.

According to an embodiment, in Formula 1-2, c1 and c2 may be equal to each other.

According to an aspect, there is provided a solid electrolyte including the solid electrolyte material, wherein the solid electrolyte is in a form of a powder or a layer.

According to an aspect of another embodiment, there is provided an all-solid secondary battery including a cathode layer; a solid electrolyte layer on the cathode layer; and an anode layer on the solid electrolyte layer, wherein at least one of the cathode layer, the solid electrolyte layer, or the anode layer comprises the solid electrolyte material.

According to an aspect, there is provided a method of preparing a solid electrolyte material, the method including: mechanically milling a mixture of a LiM2 precursor compound, a YM2 precursor compound and a M1M2 precursor compound to obtain a glass; and heat-treating the glass to obtain the solid electrolyte material represented by Formula 1

(Li₃₋ₓM1ₓ)ₐY_{b}M2_{c} Formula 1

wherein, in Formula 1,

M1 comprises at least one of Na, K, Rb, Cs, or Fr,

M2 comprises at least one of F, Cl, Br, or I,

0<x<3, 0.9≤a≤1.1, 0.9≤b≤1.1, and 5≤c≤7.

According to an embodiment, the mechanical milling may be performed under an inert atmosphere.

According to an embodiment, the heat-treating may be performed at a temperature that is greater than a glass transition temperature of the glass.

According to an embodiment, the heat-treating may include, sequentially, raising a temperature of the glass to a target heat treatment temperature, wherein the target heat treatment temperature is greater than a glass transition temperature of the glass, then heat-treating the glass at the target heat treatment temperature to form the solid electrolyte material, and then cooling the solid electrolyte material to room temperature.

According to an aspect of another embodiment, a method of manufacturing an all-solid state battery includes providing an anode layer; providing a cathode layer; and disposing a solid electrolyte layer between the anode layer and the cathode layer to manufacture the all-solid state battery, wherein at least one of the anode layer, the cathode layer, or the solid electrolyte layer includes the solid electrolyte material.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view showing an embodiment of the structure of an all-solid secondary battery;

FIG. 2 is a graph of intensity (arbitrary units) versus diffraction angle (degrees 2θ) showing the results of X-ray diffraction analysis of solid electrolyte materials according to Examples 1 to 6 and Comparative Examples 1 to 3;

FIG. 3 is a graph of intensity (arbitrary units) versus diffraction angle (degrees 2θ) showing the results of X-ray diffraction analysis of solid electrolyte materials according to Examples 1, 7, and 8; and

FIG. 4A and 4B are each a graph of current (Ampere, A) versus voltage (Volt, V) showing the initial charge-discharge curves of half cells according to Example 9 and Comparative Examples 4 and 5.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain various aspects. As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the present disclosure will be described in detail with reference to the attached drawings.

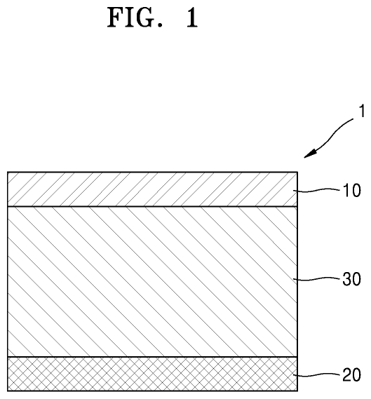

A solid electrolyte material according to an embodiment is used in, for example, an all-solid lithium secondary battery 1 as shown in FIG. 1.

### 1. Configuration of All-Solid Lithium Secondary Battery 1

Referring to FIG. 1, an all-solid lithium secondary battery 1 has a structure in which a cathode layer 10, an anode layer 20, and a solid electrolyte layer 30 between the cathode layer 10 and the anode layer 20 are stacked.

### 1.1: Cathode Layer 10

The cathode layer 10 may include a cathode active material and a solid electrolyte. In addition, the cathode layer 10 can further optionally include a cathode current collector (not shown).

The solid electrolyte included in cathode layer can be the solid electrolyte described later in the section of the solid electrolyte layer 30.

The cathode active material may be used without particular limitation as long as it is a material capable of reversibly absorbing and desorbing lithium ions.

As the cathode active material, for example, two or more kinds of composite oxides of lithium and a metal of at least one of cobalt, manganese, or nickel, may be used. As the cathode active material, for example, a compound represented by any one of the following Formulae, or a combination thereof, may be used: LiₐA_{1-b}B¹_{b}D¹₂ (where, 0.90≤a≤1.8, and 0≤b≤0.5 are satisfied); LiₐE_{1-b}B¹_{b}O_{2-c}D¹_{c} (where, 0.90≤a≤1.8, 0≤b≤0.5, and 0≤c≤0.05 are satisfied); LiE_{2-b}B¹_{b}O_{4-c}D¹_{c}(where, 0≤b≤0.5 and 0≤c≤0.05 are satisfied); LiₐNi_{1-b-c}Co_{b}B¹_{c}D¹ₐ (where, 0.90≤a≤1.8, 0≤b≤0.5, 0≤c≤0.05, and 0<α≤2 are satisfied); LiₐNi_{1-b-c}Co_{b}B¹_{c}O_{2-α}F¹_{α} (where, 0.90≤a≤1.8, 0≤b≤0.5, 0≤c≤0.05, and 0<α<2 are satisfied); LiₐNi_{1-b-c}Co_{b}B¹_{c}O_{2-α}F¹₂ (where, 0.90≤a≤1.8, 0≤b≤0.5, 0≤c≤0.05, and 0<α<2 are satisfied); LiₐNi_{1-b-c}Mn_{b}B¹_{c}D¹_{α} (where, 0.90≤a≤1.8, 0≤b≤0.5, 0≤c≤0.05, and 0<α≤2 are satisfied); LiₐNi_{1-b-c}Mn_{b}B¹_{c}O_{2-α}F¹_{α} (where, 0.90≤a≤1.8, 0≤b≤0.5, 0≤c≤0.05, and 0<α<2 are satisfied); LiₐNi_{1-b-c}Mn_{b}B¹_{c}O_{2-α}F¹₂ (where, 0.90≤a≤1.8, 0≤b≤0.5, 0≤c≤0.05, and 0<α<2 are satisfied); LiₐNi_{b}E_{c}G_{d}O₂ (where, 0.90≤a≤1.8, 0≤b≤0.9, 0≤c≤0.5, and 0.001≤d≤0.1 satisfied); LiₐNi_{b}Co_{c}Mn_{d}GeₑO₂ (where, 0.90≤a≤1.8, 0≤b≤0.9, 0≤c≤0.5, 0≤d≤0.5, and 0.001≤e≤0.1 are satisfied); LiₐNiG_{b}O₂ (where, 0.90≤a≤1.8 and 0.001≤b≤0.1 are satisfied); LiₐCoG_{b}O₂ (where, 0.90≤a≤1.8 and 0.001≤b≤0.1 are satisfied); LiₐMnG_{b}O₂ (where, 0.90≤a≤1.8 and 0.001≤b≤0.1 are satisfied); LiₐMn₂G_{b}O₄ (where, 0.90≤a≤1.8 and 0.001≤b≤0.1 are satisfied); QO₂; QS₂; LiQS₂; V₂O₅; LiV₂O₅; LiI¹O₂; LiNiVO₄; Li_{(3-f)}J₂(PO₄)₃(0≤f≤2); Li_{(3-f)}Fe₂(PO₄)₃(0≤f≤2); or LiFePO₄.

In the Formulae above, A is at least one of Ni, Co, or Mn; B¹ is at least one of Al, Ni, Co, Mn, Cr, Fe, Mg, Sr, V, or a rare earth element; D¹ is at least one of O, F, S, or P; E is at least one of Co or Mn; F¹ is at least one of F, S, or P; G is at least one of Al, Cr, Mn, Fe, Mg, La, Ce, Sr, or V; Q is at least one of Ti, Mo, or Mn; I is at least one of Cr, V, Fe, Sc, or Y; and J is at least one of V, Cr, Mn, Co, Ni, or Cu.

For example, the cathode active material may be lithium cobaltate (hereinafter referred to as LCO), lithium nickelate, lithium nickel cobaltate, lithium nickel cobalt aluminate (hereinafter referred to as NCA), lithium nickel cobalt manganate (hereinafter referred to as NCM), lithium manganate, lithium iron phosphate, nickel sulfide, copper sulfide, sulfur (monolithic sulfur), a sulfur compound, iron oxide, or vanadium oxide. These cathode active materials may be used alone, or may be used in combination of two or more of the cathode active materials.

Preferably, the cathode active material may be formed to include a lithium transition metal oxide, having a layered rock salt type structure, particularly, a lithium transition metal oxide including Li and at least one of Ni, Co, Mn, or Al and having a layered rock salt type structure, among the above-described lithium transition metal oxides. Here, the “layered” refers to the atomic structure of the material in which the atoms are arranged in layers, e.g., isostructural with α-NaFeO₂. In an aspect, the “rock salt type structure” refers to a sodium chloride type structure, and, specifically, refers to a structure in which a face-centered cubic lattice, formed from cations and anions, are arranged to be displaced from each other by ½ of a ridge of a unit lattice.

As the lithium transition metal oxide having such a layered rock salt type structure, a lithium ternary transition metal oxide, such as LiNiₓCo_{y}Al_{z}O₂ (NCA), or LiNi_{x′}Co_{y′}Mn_{z′}O₂ (NCM) (0<x<1,0<y<1,0<z<1, x+y+z=1, 0<x′<1,0<y′<1,0<z′<1, x′+y′+z′=1), may be exemplified.

When the cathode active material includes a lithium transition metal oxide having the layered rock salt type structure, a relatively high charging voltage may be obtained, and the energy density and thermal stability of the all-solid secondary battery 1 may be improved.

The cathode active material may be covered by a coating layer. Here, the coating layer may be any suitable coating layer of a cathode active material of an all-solid secondary battery. The coating layer is made of, for example, Li₂O—ZrO₂.

When the cathode active material includes nickel (Ni) as a lithium ternary transition metal oxide, such as NCA or NCM, the capacity density of the all-solid secondary battery 1 is increased, whereby metal elution of the cathode active material in a charged state may be reduced. Thus, the long-term reliability and cycle characteristics in the charge state of the all-solid secondary battery 1 may be improved.

Here, the shape of the cathode active material may be a particle shape such as a sphere or an elliptical sphere. Further, the particle diameter of the cathode active material is not particularly limited and is within a range applicable to an all-solid secondary battery. Further, the content of the cathode active material in the cathode layer 10 may not be particularly limited, and may be within a range applicable to an all-solid secondary battery.

The cathode layer 10 may further include at least one of a conducting agent, a binder, a filler, a dispersant, or an ion conducting agent, in addition to those described above. Examples of the conducting agent capable of being blended into the cathode layer 10 include graphite, carbon black, acetylene black, Ketjen black, carbon fiber, or a metal powder. Examples of the binder capable of being blended into the cathode layer 10 include styrene-butadiene rubber (SBR), polytetrafluoroethylene, polyvinylidene fluoride, or polyethylene. Moreover, as the filler, dispersant, or ion conducting agent capable of being blended into the cathode layer 10, suitable materials used in electrodes of all-solid lithium-ion secondary batteries may be used.

The all-solid lithium-ion secondary battery 1 may further include a cathode current collector for supplying current to the cathode layer 10. The cathode current collector may be disposed on the outer surface of the cathode layer 10. As the cathode current collector, for example, a plate or foil made of indium (In), magnesium (Mg), stainless steel, titanium (Ti), iron (Fe), cobalt (Co), nickel (Ni), zinc (Zn), aluminum (Al), germanium (Ge), or an alloy thereof, may be used.

### 1.2: Anode Layer 20

The anode layer 20 may include an anode active material and a solid electrolyte. In addition, the anode layer 20 can further optionally include an anode current collector (not shown).

The solid electrolyte can be the solid electrolyte described later in the section of the solid electrolyte layer 30.

The anode active material having a lower charge/discharge voltage than that of the cathode active material and may form an alloy or compound with lithium, or may be capable of reversible absorption and desorption of lithium.

Since the anode active material may form an alloy or compound with lithium, metal lithium may be deposited on an anode active material layer including the anode active material.

First, in the initial stage of charging, lithium is absorbed in the anode active material layer because the anode active material in the anode active material layer forms an alloy or compound with lithium ions. Then, after exceeding the capacity of the anode active material layer, lithium metal is deposited on one surface or both surfaces of the anode active material layer. A metal layer is formed by this deposited lithium metal. While not wanting to be bound by theory, it is understood that because the lithium metal is formed from lithium ions diffusing through the anode active material, the lithium metal is uniformly deposited on the surface of the anode active material layer, rather than being formed in a dendritic phase. During discharge, the lithium metal in the anode active material layer and the metal layer are both ionized and move toward the cathode layer. Therefore, as a result, because lithium metal may be used as an anode active material, energy density can be improved.

In addition, when the lithium metal layer is formed between the anode active material layer and the anode current collector, the anode active material layer covers the lithium metal layer. Accordingly, the anode active material layer functions as a protective layer of the lithium metal layer. Accordingly, a short circuit of the all-solid secondary battery and a decrease in capacity of the all-solid secondary battery can be suppressed, and further, characteristics of the all-solid secondary battery can be improved.

As a method of enabling the deposition of lithium metal in the anode active material layer, a method of increasing the charging capacity of the cathode active material layer such that the capacity of the cathode active material layer is greater than the charging capacity of the anode active material layer is exemplified. Specifically, the ratio (capacity ratio) between a cathode charging capacity a (milliampere hour, mAh) of the cathode active material layer and an anode charging capacity b (mAh) of the anode active material layer may satisfy a relationship of the following Equation (I).

0.002<b/a<0.5 (I)

When the capacity ratio represented by Equation (I) is 0.002 or less, depending on the configuration of the anode active material layer, the characteristics of the all-solid secondary battery may be deteriorated. Without wishing to be bound by theory, it is believed that the reason for the deterioration may be that the anode active material layer does not sufficiently mediate the deposition of lithium metal from lithium ions, and the lithium metal layer is not formed with suitable uniformity. In this case, there is a possibility that the anode active material layer collapses due to repeated charging and discharging, and thus dendrites may be deposited and grown. As a result, characteristics of the all-solid secondary battery deteriorate. Further, when the lithium metal layer is formed between the anode active material layer and the anode current collector, the anode active material layer may not fully function as a protective layer. Preferably, the capacity ratio (b/a) is about 0.005 or more, or about 0.01 or more, e.g., 0.004<b/a<0.4, 0.01<b/a<0.3, or 0.02<b/a<0.1.

When the capacity ratio is about 0.5 or more, the anode active material layer stores most of lithium during charging, and thus the metal layer may not be sufficiently formed depending on the configuration of the anode active material layer. Preferably, the capacity ratio is about 0.1 or less, or about 0.04 or less.

Examples of the anode active material may include a metal anode active material and a carbon anode active material.

Examples of the metal active material may include metals such as lithium (Li), indium (In), aluminum (Al), tin (Sn), silicon (Si), or an alloy thereof.

Examples of the carbon active material may include artificial graphite, graphite, carbon fiber, resin-calcined carbon, thermal decomposition vapor deposition carbon, coke, mesocarbon microbeads (MCMB), furfuryl alcohol, polyacene, pitch-based carbon fiber, vapor deposition carbon fibers, natural graphite, or non-graphitizable carbon. These anode active materials may be used alone or may be used in combination of two or more anode active materials.

The shape of the anode active material is not particularly limited, and may be granular. The anode active material may also constitute a uniform layer, for example, a plating layer. In the former case, lithium ions may pass through a gap between the grain-shaped anode active materials to form a lithium metal layer between the anode active material layer and the anode current collector. In the latter case, a metal layer is deposited between the anode active material layer and the solid electrolyte layer.

When a material capable of forming an alloy with lithium, for example, indium (In), aluminum (Al), tin (Sn), or silicon (Si) is used as the anode active material, the anode active material layer may be a metal layer. For example, the metal layer may be a plating layer.

The anode layer may further include an additive of at least one of a conducting agent, a binder, a filler, a dispersant, or ion-conducting agent in addition to the above-described anode active material and solid electrolyte.

The additive included in the anode layer 20 may be the same as the above-described additive included in the cathode layer 10.

The all-solid lithium-ion secondary battery 1 may further include an anode current collector for supplying current to the anode layer 20. The anode current collector may be disposed on the outer surface of the anode layer 20. The anode current collector is preferably made of a material that does not react with lithium, that is, a material that does not form both an alloy and a compound. As a material constituting the anode current collector, for example, at least one of indium (In), copper (Cu), magnesium (Mg), stainless steel, titanium (Ti), iron (Fe), cobalt (Co), nickel (Ni)), zinc (Zn), or germanium (Ge) may be used. The anode current collector may be made of one of these metals, or may be made of two or more types of metals or metal alloys or coating materials.

### 1.3: Solid Electrolyte Layer 30

The solid electrolyte layer 30 is an interfacial layer formed between the cathode layer 10 and the anode layer 20, and may include a solid electrolyte.

The solid electrolyte layer 30 may further include a binder. Examples of the binder included in the solid electrolyte layer 30 may include at least one of styrene butadiene (SBR), polytetrafluoroethylene, polyvinylidene fluoride, or polyethylene.

### 1.3.1: Solid Electrolyte and Solid Electrolyte Material

The solid electrolyte may be, for example, in the form of a powder made of a solid electrolyte material.

The solid electrolyte material does not contain sulfur, and instead the solid electrolyte material contains a halogen element, a lithium element, a yttrium element, and an alkali metal other than lithium, and is represented by Formula 1 below. Formula 1

(Li₃₋ₓM1ₓ)ₐY_{b}M2_{c} Formula 1

In Formula 1,

M1 includes at least one of Na, K, Rb, Cs, or Fr,

M2 includes at least one of F, Cl, Br, or I,

0<x<3, 0.9≤a≤1.1, 0.9≤b≤1.1, and 5≤c≤7.

In Formula 1 above, a cation ratio M1/(Li+M1) may satisfy 0<(M1/(Li+M1))≤0.07, wherein the cation ratio is a ratio of moles of M1 to a sum of moles of Li and M1.

According to an embodiment, the cation ratio may be about 0.04 or less, e.g., 0.001<(M1/(Li+M1))≤06, or 0.01<(M1/(Li+M1))≤05. For example, the cation ratio may be about 0.02 or less. In this case, the cation ratio is a molar ratio.

According to an embodiment, in Formula 1, a and b may each be 1, and 5≤c≤7. For example, in Formula 1, a and b may each be 1, and c may be 6.

According to an embodiment, in Formula 1, M1 may include at least one of Na or K. For example, in Formula 1, M1 may be Na or K.

According to an embodiment, in Formula 1, M2 may include at least one of Cl or Br. For example, in Formula 1, M2 may include Cl and Br.

According to an embodiment, x may satisfy 0<x≤0.21.

According to an embodiment, when analyzed by X-ray diffraction using CuKα radiation, the solid electrolyte material represented by Formula 1 may have peaks at diffraction angles of 27.72°2θ±0.50°2θ, 31.96°2θ±0.50°2θ, 46.34°2θ±0.50°2θ, 55.19°2θ±0.50°2θ and 57.39°2θ±0.50°2θ.

According to an embodiment, the solid electrolyte material may be represented by Formula 2:

(Li₃₋ₓM1ₓ)YM2₆. Formula 2

In Formula 2,

M1 may inclue at least one of Na, K, Rb, Cs, or Fr,

M2 may inclue at least one of F, Cl, Br, or I, and

x is more than 0 and less than 3.

In Formula 2, M1 may include at least one of Na, K, Rb, Cs or Fr, for example, may include at least one of Na or K.

In Formula 2, M2 may include at least one of Cl, Br, I or F, for example, may include at least one of Cl or Br.

According to an embodiment, in Formula 2, M2 may include Cl and Br. When M2 includes Cl and Br, the content of Cl may be the same as or different from the content of Br.

In Formula 2, x may exceed 0, and for example, x may be more than 0 and less than or equal to 0.21.

In Formula 2, a cation ratio M1/(Li+M1) may satisfy 0<(M1/(Li+M1))≤0.07, wherein the cation ratio is a ratio of moles of M1 to a sum of moles of Li and M1.

According to an embodiment, the cation ratio may be about 0.04 or less. For example, the cation ratio may be about 0.02 or less, e.g., 0.001<(M1/(Li+M1))≤06, or 0.01<(M1/(Li+M1))≤0.05. In this case, the cation ratio is a molar ratio.

According to an embodiment, the solid electrolyte material may be represented by Formula 1-1 below:

(Li₃₋ₓM1ₓ)ₐY_{b}(M21_{1-α}M22_{α})_{c}. Formula 1-1

In Formula 1-1,

M1 includes at least one of Na, K, Rb, Cs, or Fr,

M21 and M22 are each independently at least one of F, Cl, Br, or I,

M21 and M22 are different from each other,

0<x<3, 0.9≤a≤1.1, 0.9≤b≤1.1, 5≤c≤7, and 0<α<1.

For example, M21 may be Br, and M22 may be Cl.

According to an embodiment, the solid electrolyte material may be represented by Formula 1-2 below:

(Li₃₋ₓM1ₓ)YM21_{c1}M22_{c2}. Formula 1-2

In Formula 1-2,

M1 includes at least one of Na, K, Rb, Cs, or Fr,

M21 and M22 are each independently one of F, Cl, Br, or I,

M21 and M22 are different from each other,

0<x<3, 0<c1<6, 0<c2<6, and 5≤c1+c2≤7.

According to an embodiment, c1 and c2 may be the same as or different from each other, for example, c1 and c2 may be the same as each other.

Examples of the solid electrolyte material according to an embodiment may include (Li₃₋ₓM1ₓ)Y(Cl_{6-y}Br_{y})(0<x≤0.2, 2≤y<6 or 2≤y≤4 or 2≤y≤3), (Li₃₋ₓM1ₓ)YCl₃Br₃(0<x≤0.2), or (Li₃₋ₓM1ₓ)YBr₆(0<x≤0.2).

Specific examples of the solid electrolyte material according to an embodiment may include Li_{2.9875}Na_{0.0125}YCl₃Br₃, Li_{2.975}Na_{0.025}YCl₃Br₃, Li_{2.95}Na_{0.05}YCl₃Br₃, Li_{2.9}Na_{0.1}YCl₃Br₃, Li_{2.8}Na_{0.2}YCl₃Br₃, Li_{2.96}Na_{0.04}YCl₃Br₃, Li_{2.95}K_{0.05}YCl₃Br₃, or Li_{2.9}K_{0.1}YCl₃Br₃.

In addition to the disclosed solid electrolyte material, an oxide solid electrolyte may be included if desired. The oxide solid electrolyte may comprise at least one of Li_{1+x+y}AlₓTi₂₋ₓSi_{y}P_{3-y}O₁₂ (where 0<x<2 and 0≤y<3), BaTiO₃, Pb(ZrₐTi₁₋ₐ)O₃ (PZT) (where 0≤a≤1), Pb₁₋ₓLaₓZr_{1-y} Ti_{y}O₃ (PLZT) (where 0≤x<1 and 0≤y<1), Pb(Mg_{1/3}Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (where 0<x<2 and 0<y<3), LiₓAl_{y}Ti_{z}(PO₄)₃ (where 0<x<2, 0<y<1, and 0<z<3), Li_{1'x+y}(AlₐGa₁₋ₐ)ₓ(Ti_{b}Ge_{1-b})₂₋ₓSi_{y}P_{3-y}O₁₂ (where 0≤x≤1, 0≤y≤1, 0≤a≤1, and 0≤b≤1), LiₓLa_{y}TiO₃ (where 0<x<2 and 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (where M is Te, Nb, or Zr, and 0≤x≤10), or a carnet-type solid electrolyte such as Li₇La₃Zr₂O₁₂ (LLZO) or Li₃₊ₓLa₃Zr₂₋ₐMₐO₁₂ (M-doped LLZO, where M is Ga, W, Nb, Ta, or Al, and 0≤x≤10 and 0≤a<2).

Next, a method of manufacturing an all-solid lithium-ion secondary battery including the above-described solid electrolyte material will be described.

### 2. Method of Manufacturing All-Solid Lithium-Ion Secondary Battery

An all-solid lithium-ion secondary battery 1 may be manufactured by preparing a cathode layer 10, an anode layer 20, and a solid electrolyte layer 30 and then laminating these layers. Hereinafter, each process will be further described.

### 2.1: Process of Preparing Cathode Layer 10

The method of preparing the cathode layer 10 is not particularly limited, and for example the cathode layer 10 may be prepared by the following processes.

A slurry (or paste) is prepared by adding materials (a cathode active material, a binder, and the like) constituting the cathode layer 10 to a non-polar solvent. Then, the prepared slurry is applied on a cathode current collector and dried to obtain a laminate. Then, the obtained laminate is pressed (for example, a pressing process using static pressure is performed) to prepare a cathode layer 10. Also, the pressing process may be omitted. The cathode layer 10 may also be prepared by compacting a mixture of materials constituting the cathode layer 10 into a pellet shape or extruding the mixture into a sheet shape. When the cathode layer 10 is prepared in this way, the cathode current collector may be omitted.

### 2.2: Preparation of Anode Layer 20

The method of preparing the anode layer 20 is not particularly limited, and for example, the anode layer 20 may be prepared by the following processes.

When a metal foil containing lithium is used as the anode active material, for example, the anode layer 20 may be prepared by pressing a metal foil containing lithium, such as a lithium metal foil, on the anode current collector.

When using an anode active material other than a lithium metal foil, for example, a slurry is prepared by adding materials (an anode active material particles, a solid electrolyte, a binder, and the like) constituting the anode layer 20 to a non-polar solvent. Then, the prepared slurry is applied on an anode current collector and dried to obtain a laminate. Then, the obtained laminate is pressed (for example, a pressing process using static pressure is performed) to prepare an anode layer 20. Meanwhile, the pressing process may be omitted. Further, the anode layer 20 may also be prepared by pressing a mixture of materials constituting the anode layer 20.

### 2.3: Process of Preparing Solid Electrolyte Layer 30

The solid electrolyte layer 30 may be prepared using a solid electrolyte including the above-described solid electrolyte material.

### 2.3.1: Method of Preparing Solid Electrolyte Material

The above-described solid electrolyte material may be prepared by the following procedures and processes.

Each reagent of LiM2, YM2 and M1M2 as a starting material is weighed and mixed such that the final composition becomes the target composition, for example, (Li₃₋ₓM1ₓ)Y(M21_{6-y}M22_{y}) (where x is greater than 0 and less than 3, and y is greater than 0 and less than 6). Here, both M21 and M22 are elements included in M2, and are different from each other. In an embodiment, two elements M21 and M22 are used as M2 elements. M2 element may consist of one element or may consist of two or more elements.

The mixture obtained by mixing the above starting materials is subjected to mechanical milling with, for example, zirconium balls, or in a planetary mixer to obtain a glass. The mechanical milling may be performed under conditions of about 50 revolutions/minute or more and about 600 revolutions/minute or less, about 0.1 hour or more and about 50 hours or less, and about 1 kWh/starting material mixture 1 kg or more and about 100 kWh/starting material mixture of about 1 kg or less. By the mechanical milling, the starting materials included in the above-mentioned mixture react with each other to form a powdered glass.

Next, the obtained glass is heat-treated to generate microcrystals, and glass ceramics, which are aggregates of these microcrystals, are obtained. The heat treatment may be performed at a temperature greater than or equal to the glass transition temperature of the glass obtained by the above-described mechanical milling process using, for example, an electric furnace. Specifically, the heat treatment may be performed by gradually increasing the temperature in a heat treatment device such as an electric furnace from room temperature to a target temperature, which is greater than the glass transition temperature, so that the mixture inside the heat treatment device has a temperature at or above the glass transition temperature of the glass, preferably above the glass transition temperature of the glass, maintaining the temperature for a certain period of time after reaching the target temperature, and then gradually lowering the temperature to return to room temperature. The target temperature may be appropriately changed according to the glass transition temperature of the glass to be subjected to heat treatment, and may be, for example, about 400° C. or higher and about 1000° C. or lower, or about 500° C. to about 900° C. The time for maintaining the temperature after reaching the target temperature may be, for example, about 1 hour or more and about 20 hours or less.

The glass ceramic obtained in this way is used as a solid electrolyte material.

Specifically, the solid electrolyte layer 30 may be prepared by forming the solid electrolyte into a film using a film forming method such as aerosol deposition, cold spraying, or sputtering. The solid electrolyte layer 30 may be prepared by pressing particles of the solid electrolyte in only a particle state without suspending the particles of the solid electrolyte in a solvent or the like. Further, the solid electrolyte layer 30 may be prepared by mixing a solid electrolyte, a solvent, and a binder to obtain a mixture and then applying, drying and pressing the mixture.

### 2.4: Lamination of Respective Layers

The cathode layer 10, the anode layer 20, and the solid electrolyte layer 30, having been obtained as described above, can be laminated such that the solid electrolyte layer 30 is between the cathode layer 10 and the anode layer 20, and pressed in a lamination direction, to manufacture the all-solid lithium-ion secondary battery 1.

### 3: Effects of the Present Embodiment

The solid electrolyte material as described herein can have high ionic conductivity without generating hydrogen sulfide.

As the solid electrolyte material according to the embodiment is used as a solid electrolyte, in the all-solid lithium-ion secondary battery 1, which has no risk of generating hydrogen sulfide, the ionic conductivity of the solid electrolyte layer may be improved compared to that in the art.

The present disclosure is not limited to the above-described embodiment.

For example, in the above-described embodiment, it has been described that the solid electrolyte is made of a solid electrolyte material, and since the solid electrolyte may contain a solid electrolyte material, the solid electrolyte may further contain components other than the disclosed solid electrolyte material.

In the above-described embodiment, the case of using the solid electrolyte material as a solid electrolyte in an all-solid lithium-ion secondary battery has been specifically described, but the solid electrolyte material related to the present disclosure may be used in all-solid batteries other than the all-solid lithium-ion secondary battery.

In addition, unless it is contrary to the meaning of the present disclosure, various modifications or combination of embodiments may also be applied.

### EXAMPLES

Hereinafter, various examples of the present disclosure will be described in detail. However, the scope of the present disclosure is not limited to these examples.

In examples of the present disclosure, a plurality of types of solid electrolyte materials having different compositions were prepared, and X-ray crystal diffraction and ionic conductivity measurements were performed on each of the prepared solid electrolyte materials.

Example 1

Reagents LiBr, YCl₃, and NaBr were weighed to obtain a target composition (Li_{2.9875}Na_{0.0125})YCl₃Br₃, and were then subjected to mechanical milling with zirconium balls and mixing this composition for 20 hours. The mechanical milling was performed for 20 hours at a rotation speed of 380 rpm, at room temperature, and under an argon atmosphere.

A powder sample of the composition of (Li_{2.9875}Na_{0.125})YCl₃Br₃ obtained by the above mechanical milling was covered with a gold foil, and put into a carbon crucible again. After the carbon crucible was vacuum-sealed in a quartz glass tube, heat treatment was performed on the powder sample using an electric furnace. The internal temperature of the electric furnace was raised from room temperature to 550° C. at a rate of 1.0° C./min, and heat treatment was performed at 550° C. for 12 hours. Thereafter, the internal temperature of the electric furnace was lowered from 550° C. to room temperature at a rate of 1.0° C./min, and the electric furnace was cooled to room temperature (23° C.) to recover a sample.

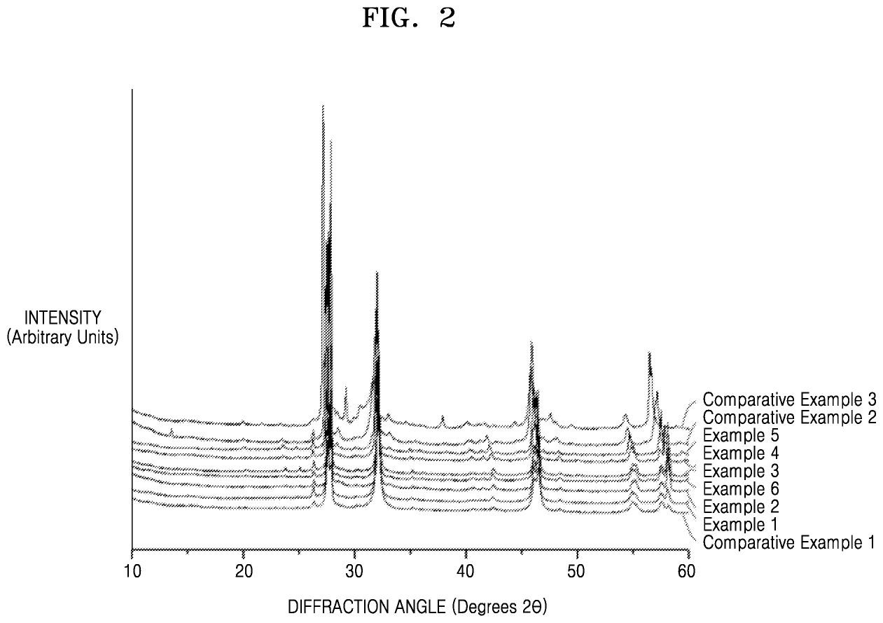

After the recovered sample was pulverized by an agate mortar, X-ray powder diffraction was performed to confirm that target halogen-based crystals were produced (refer to FIG. 2). For the X-ray powder diffraction, Smart Lab 9 Kw, which is a multi-purpose powerful X-ray diffraction device manufactured by Rigaku Co., Ltd., was used. Cu was used as a target of X-ray tube, and measurement was performed at 0.01° intervals from 2θ=5° to 2θ=90°.

The ionic conductivity of the obtained material was measured according to the following method.

The sample pulverized by the agate mortar was pressed (pressure: 400 megapascals per square centimeter, MPa/cm²) to produce pellets. An In foil (thickness: 500 μm) was attached to both sides of the pellet to make a pellet for ionic conductivity measurement. AC impedance was measured in the frequency range of 100 milliHertz (mHz) to 1 megaHertz (MHz) using AUTOLAB PGSTAT 30 of Metrohm Autolab Inc. Further, temperature variable test was performed at 10° C. intervals from −20° C. to 80° C. using ESPEC TH-241 thermostat of Espec company. The ionic conductivity at room temperature obtained through this measurement method was 2.7×10⁻³ Siemens per centimeter (S/cm).

### Example 2

A solid electrolyte material was prepared using the same method as in Example 1. Further, as the target composition of the solid electrolyte material of Example 2, (Li_{2.975}Na_{0.25})YCl₃Br₃ was used. The X-ray powder diffraction pattern measured for this solid electrolyte material is shown in FIG. 2. From the results of FIG. 2, it may be found that halogen-based crystals as the target composition were produced.

The ionic conductivity of the obtained solid electrolyte material was 3.4×10⁻³ S/cm at 25° C.

### Example 3

A solid electrolyte material was prepared using the same method as in Example 1. Further, as the target composition of the solid electrolyte material of Example 3, (Li_{2.95}Na_{0.05})YCl₃Br₃ was used. The X-ray powder diffraction pattern measured for this solid electrolyte material is shown in FIG. 2. From the results of FIG. 2, it may be found that halogen-based crystals as the target composition were produced.

The ionic conductivity of the obtained solid electrolyte material was 2.9×10⁻³ S/cm at 25° C.

### Example 4

A solid electrolyte material was prepared using the same method as in Example 1. Further, as the target composition of the solid electrolyte material of Example 4, (Li₂₉Na_{0.1})YCl₃Br₃was used. The X-ray powder diffraction pattern measured for this solid electrolyte material is shown in FIG. 2. From the results of FIG. 2, it may be found that halogen-based crystals as the target composition were produced.

The ionic conductivity of the obtained solid electrolyte material was 2.8×10⁻³ S/cm at 25° C.

### Example 5

A solid electrolyte material was prepared using the same method as in Example 1. Further, as the target composition of the solid electrolyte material of Example 5, (Li_{2.8}Na_{0.2})YCl₃Br₃ was used. The X-ray powder diffraction pattern measured for this solid electrolyte material is shown in FIG. 2. From the results of FIG. 2, it may be found that halogen-based crystals as the target composition were produced.

The ionic conductivity of the obtained solid electrolyte material was 2.2×10⁻³ S/cm at 25° C.

### Example 6

A solid electrolyte material was prepared using the same method as in Example 1. Further, as the target composition of the solid electrolyte material of Example 6, (Li_{2.96}Na_{0.04})YCl₃Br₃ was used. The X-ray powder diffraction pattern measured for this solid electrolyte material is shown in FIG. 2. From the results of FIG. 2, it may be found that halogen-based crystals as the target composition were produced.

The ionic conductivity of the obtained solid electrolyte material was 3.0×10⁻³ S/cm at 25° C.

### Example 7

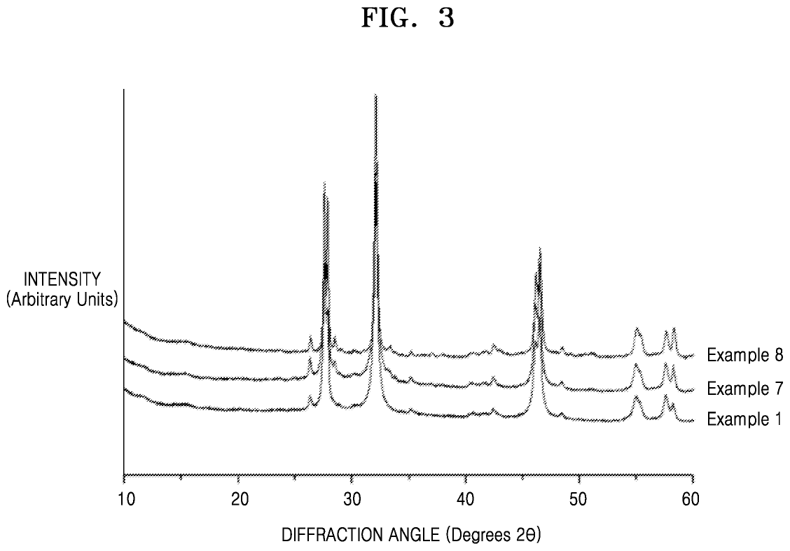

A solid electrolyte material was prepared using the same method as in Example 1. Further, as the target composition of the solid electrolyte material of Example 7, (Li_{2.95}K_{0.05})YCl₃Br₃was used. The X-ray powder diffraction pattern measured for this solid electrolyte material is shown in FIG. 3. From the results of FIG. 3, it may be found that halogen-based crystals as the target composition were produced.

The ionic conductivity of the obtained solid electrolyte material was 2.0×10⁻³ S/cm at 25° C.

### Example 8

A solid electrolyte material was prepared using the same method as in Example 1. Further, as the target composition of the solid electrolyte material of Example 8, (Li_{2.9}K_{0.1})YCl₃Br₃ was used. The X-ray powder diffraction pattern measured for this solid electrolyte material is shown in FIG. 3. From the results of FIG. 3, it may be found that halogen-based crystals as the target composition were produced.

The ionic conductivity of the obtained solid electrolyte material was 1.7×10⁻³ S/cm at 25° C.

### Comparative Example 1

A solid electrolyte material was prepared using the same method as in Example 1. Further, as the target composition of the solid electrolyte material of Comparative Example 1, Li₃YCl₃Br₃ was used. The X-ray powder diffraction pattern measured for this solid electrolyte material is shown in FIG. 2. From the results of FIG. 2, it may be found that halogen-based crystals as the target composition were produced.

The ionic conductivity of the obtained solid electrolyte material was 1.5×10⁻³ S/cm at 25° C.

### Comparative Example 2

A solid electrolyte material was prepared using the same method as in Example 1. Further, as the target composition of the solid electrolyte material of Comparative Example 2, Li_{2.6}Na_{0.4}YCl₃Br₃ was used. The X-ray powder diffraction pattern measured for this solid electrolyte material is shown in FIG. 2. From the results of FIG. 2, it may be found that halogen-based crystals as the target composition were produced.

The ionic conductivity of the obtained solid electrolyte material was 9.4×10⁻⁴ S/cm at 25° C.

### Comparative Example 3

A solid electrolyte material was prepared using the same method as in Example 1. Further, as the target composition of the solid electrolyte material of Comparative Example 3, Li_{2.4}Na_{0.6}YCl₃Br₃ was used. The X-ray powder diffraction pattern measured for this solid electrolyte material is shown in FIG. 2. From the results of FIG. 2, it may be found that halogen-based crystals as the target composition were produced.

The ionic conductivity of the obtained solid electrolyte material was 1.5×10⁻⁴ S/cm at 25° C.

The above results are summarized in Table 1 below.

TABLE 1

| | | | Ionic |
|---|---|---|---|
| | | Cation ratio | conductivity |
| | Composition | ( = M1/(Li + M1 )) | (25° C.)(S/cm) |
| Example 1 | Li_{2.9875}Na_{0.0125}YCl₃Br₃ | 0.004 | 2.7 × 10⁻³ |
| Example 2 | Li_{2.975}Na_{0.025}YCl₃Br₃ | 0.008 | 3.4 × 10⁻³ |
| Example 3 | Li_{2.95}Na_{0.05}YCl₃Br₃ | 0.017 | 2.9 × 10⁻³ |
| Example 4 | Li_{2.9}Na_{0.1}YCl₃Br₃ | 0.033 | 2.8 × 10⁻³ |
| Example 5 | Li_{2.8}Na_{0.2}YCl₃Br₃ | 0.067 | 2.2 × 10⁻³ |
| Example 6 | Li_{2.96}Na_{0.04}YCl₃Br₃ | 0.013 | 3.0 × 10⁻³ |
| Example 7 | Li_{2.95}K_{0.05}YCl₃Br₃ | 0.017 | 2.0 × 10⁻³ |
| Example 8 | Li_{2.9}K_{0.1}YCl₃Br₃ | 0.033 | 1.7 × 10⁻³ |
| Comparative | Li₃YCl₃Br₃ | 0.000 | 1.5 × 10⁻³ |
| Example 1 | | | |
| Comparative | Li_{2.6}Na_{0.4}YCl₃Br₃ | 0.133 | 9.4 × 10⁻⁴ |
| Example 2 | | | |
| Comparative | Li_{2.4}Na_{0.6}YCl₃Br₃ | 0.200 | 1.5 × 10⁻⁴ |
| Example 3 | | | |

From the results of Table 1, it may be found that in Examples 1 to 8 where alkali metal elements other than lithium elements are contained in addition to lithium elements, yttrium elements, and halogen elements, the cation ratio is more than 0 and 0.07 or less, ionic conductivity of 1.6×10⁻³ S/cm or more, which is a boundary where commercialization is possible, is exhibited.

Also, it may be found that in Comparative Example 1 where an alkali metal element other than lithium is not included, ionic conductivity is less than 1.6×10⁻³ S/cm.

As a result, it was found that, in a solid electrolyte material containing no sulfur and containing a halogen element, the ionic conductivity of a solid electrolyte material containing lithium and yttrium and also containing an alkali metal other than lithium, may be improved.

Further, although not disclosed, one of skill in the art would expect that the same results as those in these examples may be obtained even when only Cl or Br are used as M2.

### Example 9

In order to perform the evaluation of cathode and anode stability on the solid electrolyte material obtained in Example 2, a half cell was assembled. A cylindrical plastic case (diameter: 13 mm) was sequentially filled with a SUS electrode, a lithium metal thin film (20 μm), a solid electrolyte (200 mg), and a SUS operation electrode, and then uniaxially pressed by a pressure of 300 MPa to manufacture a half cell.

### Comparative Example 4

A half cell of an all-solid secondary battery was manufactured in the same method as in Example 9, except that the solid electrolyte material of Comparative Example 1 was used instead of the solid electrolyte obtained in Example 2.

### Comparative Example 5

An all-solid secondary battery half cell was manufactured in the same method as in Example 9, except that after preparing a solid electrolyte material by weighing reagents LiBr, YCl₃, and NaBr to obtain a target composition Li₃YCl_{4.5}Br_{1.5} using the same method as in Example 1, this solid electrolyte material was used instead of the solid electrolyte obtained in Example 2.

### Evaluation Example 1: Evaluation of Battery Characteristics

Cyclic voltammetry was measured at 0.1 mV/sec (millivolts per second) at an operation electrode potential of −0.3V to 5V for the all-solid secondary battery half cells manufactured in Example 9 and Comparative Examples 4 and 5, respectively.

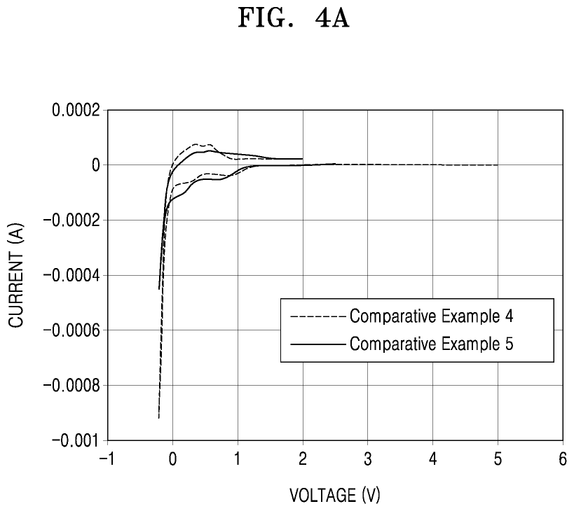

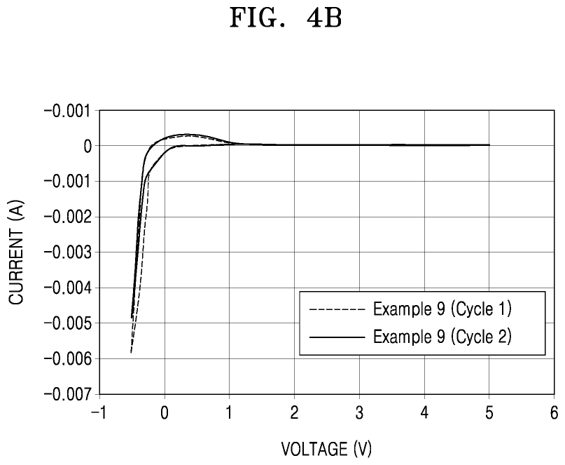

The amount of change in a current with respect to the operation electrode potential was measured and shown as a graph in FIGS. 4A and 4B.

Referring to FIGS. 4A and 4B, it may be found that the all-solid secondary battery (Example 9) including the solid electrolyte material of Example 2 does not exhibit a clear oxidation-reduction reaction at a high potential of 5V, which suggests that this solid electrolyte may be used as an electrolyte for a cathode. Further, in the solid electrolyte of Example 2, a reduction current starts to flow at 0.2 V even at a low potential, and is lower than those of Comparative Examples 4 and 5, thereby exhibiting excellent anode stability.

According to an aspect, it is possible to provide a solid electrolyte material having high ionic conductivity and avoid the risk of producing hydrogen sulfide.

It should be understood that embodiments described herein should be considered in a descriptive sense only and not for purposes of limitation. Descriptions of features or aspects within each embodiment should be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A solid electrolyte material represented by Formula 1:
(Li₃₋ₓM1ₓ)ₐY_{b}M2_{c} Formula 1
wherein, in Formula 1,
M1 comprises at least one of Na, K, Rb, Cs, or Fr,
M2 comprises at least one of F, Cl, Br, or I,
0<x<3, 0.9≤a≤1.1, 0.9≤b≤1.1, and 5≤c≤7.

2. The solid electrolyte material of claim 1,
wherein a cation ratio satisfies 0<(M1/(Li+M1))≤0.07, wherein the cation ratio is a ratio of moles of M1 to a sum of moles of Li and M1.

3. The solid electrolyte material of claim 1,
wherein a and b are each 1, and 5≤c≤7.

4. The solid electrolyte material of claim 1,
wherein, when analyzed by X-ray diffraction using CuKα radiation, the solid electrolyte material has peaks at diffraction angles of 27.72°2θ±0.50°2θ, 31.96°2θ±0.50°2θ, 46.34°2θ±0.50°2θ, 55.19°2θ±0.50°2θ and 57.39°2θ±0.50°2θ.

5. The solid electrolyte material of claim 1,
wherein 0<x≤0.21.

6. The solid electrolyte material of claim 1,
wherein M1 comprises at least one of Na or K.

7. The solid electrolyte material of claim 1,
wherein M2 comprises at least one of Cl or Br.

8. The solid electrolyte material of claim 1,
wherein the solid electrolyte material is represented by Formula 1-1:
(Li₃₋ₓM1ₓ)ₐY_{b}(M21_{1-α}M22_{α})_{c} Formula 1-1
wherein, in Formula 1-1,
M1 comprises at least one of Na, K, Rb, Cs, or Fr,
M21 and M22 are each independently at least one of F, Cl, Br, or I,
M21 and M22 are different from each other,
0<x<3, 0.9≤a≤1.1, 0.9≤b≤1.1, 5≤c≤7, and 0<α<1.

9. The solid electrolyte material of claim 8,
wherein M21 is Br, and M22 is Cl.

10. The solid electrolyte material of claim 9,
wherein the solid electrolyte material is represented by Formula 1-2:
(Li₃₋ₓM1ₓ)YM21_{c1}M22_{c2} Formula 1-2
wherein, in Formula 1-2,
M1 comprises at least one of Na, K, Rb, Cs, or Fr,
M21 and M22 are each independently at least one of F, Cl, Br, or I,
M21 and M22 are different from each other,
0<x<3, 0<c1<6, 0<c2<6, and 5≤(c1+c2)≤7.

11. The solid electrolyte material of claim 10,
wherein c1 and c2 are equal to each other.

12. The solid electrolyte material of claim 1,
wherein the solid electrolyte material is at least one of (Li₃₋ₓM1ₓ)Y(Cl_{6-y}Br_{y}) wherein 0<x≤0.2, and 2≤y<6), (Li₃₋ₓM1ₓ)YCl₃Br₃ wherein 0<x≤0.2, or (Li₃₋ₓM1ₓ)YBr₆ wherein 0<x≤0.2).

13. The solid electrolyte material of claim 1,
wherein the solid electrolyte material is at least one of Li_{2.9875}Na_{0.0125}YCl₃Br₃, Li_{2.975}Na_{0.25}YCl₃Br₃, Li_{2.95}Na_{0.05}YCl₃Br₃, Li_{2.9}Na_{0.1}YCl₃Br₃, Li_{2.8}Na_{0.2}YCl₃Br₃, Li_{2.96}Na_{0.04}YCl₃Br₃, Li_{2.95}K_{0.05}YCl₃Br₃, or Li_{2.9}K_{0.1}YCl₃Br₃.

14. A solid electrolyte comprising the solid electrolyte material of claim 1, wherein the solid electrolyte is in a form of a powder or a layer.

15. An all-solid secondary battery comprising:
a cathode layer;
a solid electrolyte layer on the cathode layer; and
an anode layer on the solid electrolyte layer,
wherein at least one of the cathode layer, the solid electrolyte layer, or the anode layer comprises the solid electrolyte material of claim 1.

16. The all-solid secondary battery of claim 15, wherein the solid electrolyte layer comprises the solid electrolyte material of claim 1.

17. A method of preparing a solid electrolyte material, the method comprising:
mechanically milling a mixture of a LiM2 precursor compound, a YM2 precursor compound and a M1M2 precursor compound to obtain a glass; and
heat-treating the glass to obtain a solid electrolyte material represented by Formula 1:
(Li₃₋ₓM1ₓ)ₐY_{b}M2_{c} Formula 1
wherein, in Formula 1,
M1 comprises at least one of Na, K, Rb, Cs, or Fr,
M2 comprises at least one of F, Cl, Br, or I,
0<x<3, 0.9≤a≤1.1, 0.9≤b≤1.1, and 5≤c≤7.

18. The method of claim 17,
wherein a cation ratio satisfies 0<(M1/(Li+M1))≤0.07, wherein the cation ratio is a ratio of moles of M1 to a sum of moles of Li and M1,

19. The method of claim 17,
wherein the mechanical milling is performed under an inert atmosphere.

20. The method of claim 17,
wherein the heat-treating is performed at a temperature higher than a glass transition temperature of the glass.

21. The method of claim 20,
wherein the heat-treating comprises, sequentially, raising a temperature of the glass to a target heat treatment temperature, wherein the target heat treatment temperature is higher than a glass transition temperature of the glass, then heat-treating the glass at the target heat treatment temperature to form the solid electrolyte material, and then cooling the solid electrolyte material- to room temperature.

22. A method of manufacturing an all-solid state battery, the method comprising:
providing an anode layer;
providing a cathode layer; and
disposing a solid electrolyte layer between the anode layer and the cathode layer to manufacture the all-solid state battery,
wherein at least one of the anode layer, the cathode layer, or the solid electrolyte layer comprises the solid electrolyte material of claim 1.
